(19) United States
(12) Patent Application Publication
(10) Pub. No.: US 2025/0360826 A1
(43) Pub. Date: Nov. 27, 2025

(54) BATTERY PACK FOR AN ELECTRIC VEHICLE

(71) Applicant: BOMBARDIER RECREATIONAL PRODUCTS INC., Valcourt (CA)

(72) Inventors: Normand LEBREUX, Sherbrooke (CA); Jean-Yves DOYON, Sherbrooke (CA); Bastien MONY, Sherbrooke (CA); Jasmin ROULEAU, Waterville (CA)

(21) Appl. No.: 18/873,898

(22) PCT Filed: Jun. 13, 2023
(86) PCT No.: PCT/IB2023/056106

§ 371 Date: Dec. 11, 2024

Related U.S. Application Data
(60) Provisional application No. 63/354,082, filed on Jun. 21, 2022.

(51) Int. Cl. B60L 53/62; B60L 50/64; B60L 53/20; H01M 10/42; H01M 10/48; H01M 50/213; H01M 50/249; H01M 50/271; H01M 50/509

(52) U.S. Cl. CPC B60L 53/62; B60L 50/64; B60L 53/20; H01M 10/425; H01M 10/482; H01M 10/486; H01M 50/213; H01M 50/249; H01M 50/271; H01M 50/509; B60L 2210/10; B60L 2240/547; H01M 2010/4271; H01M 2220/20

(57) ABSTRACT

A battery pack for an electric vehicle, the battery pack including a battery housing; a general battery management system (general BMS) disposed in the battery housing; and a plurality of battery modules disposed in the battery housing, each battery module of the plurality of battery modules including a plurality of battery cells; and a module board including a module battery management system (module BMS) communicatively connected to the general BMS, the module BMS including sensors for sensing an operating condition of the plurality of battery cells; and an integrated current collector disposed within the battery module, the integrated current collector electrically coupling the battery cells together. A method for managing a battery pack of an electric vehicle, the battery pack including the general BMS operatively connected to the battery modules, each battery module including the module BMS, the method being executed by the general BMS.

### CROSS-REFERENCE

The present application claims priority to U.S. Provisional Patent Application No. 63/354,082, entitled “Battery Pack for an Electric Vehicle,” filed Jun. 21, 2022, the entirety of which is incorporated by reference herein.

### FIELD OF TECHNOLOGY

The present technology relates to battery packs for electric vehicles.

### BACKGROUND

Straddle seat vehicles, including motorcycles, all-terrain vehicles, and snowmobiles are popular transport and recreational vehicles. As the move toward electrification of vehicles progresses, interest in battery packs for various recreational vehicles increases.

Different vehicles have different power requirements, such as the total current output or total voltage across the battery assembly. In many recreational and transport vehicles, space available for different electric components such as a battery pack, charging components, and components for managing power distribution can be strictly limited. When addressing different types of vehicles with different space constraints and different power requirements, the number of designs could quickly multiply.

There therefore remains a desire for battery arrangements for electric vehicles addressing at least some of the above described disadvantages.

### SUMMARY

It is an object of the present technology to ameliorate at least some of the inconveniences present in the prior art.

According to aspects of the present technology, there is provided a battery pack for an electric vehicle. The battery pack is formed from multiple battery modules, each containing a certain number of battery cells, connected in series. By arranging the battery cells into parallelly connected subgroups within the modules, different total voltage and/or capacities can be achieved in different embodiments of battery packs by including more or fewer modules and/or changing the subgroup configuration. The battery pack functions using a split management regime, referred to as a modular BMS topology, including a general battery management system (general BMS) and a module battery management system (module BMS) for each of the battery modules. One central control is provided by the general BMS, which is communicatively and operatively connected to each module BMS, as well as other components of the powertrain. This modular BMS topology can thus be used in different embodiments with different numbers of modules without completely redesigning the battery. The modules, and the general BMS, are disposed in a generally compact housing, with the inverter and charger units connected thereto. The present technology may further provide improved flexibility for battery pack vehicle integration and reduced development costs. By combining the power circuit and battery management into a single PCB, there is also an overall reduction in the number of components. In at least some cases, the modular arrangement further provides an advantageous configuration of relatively shorter bus bars for electricity collection or charging, reducing weight and costs.

According to one aspect of the present technology, there is provided a battery pack for an electric vehicle. The battery pack includes a battery housing; a general battery management system (general BMS) disposed in the battery housing; and a plurality of battery modules disposed in the battery housing. Each battery module of the plurality of battery modules includes a plurality of battery cells; and a module board including a module battery management system (module BMS) communicatively connected to the general BMS, the module BMS including at least one sensor for sensing at least one operating condition of the plurality of battery cells; and an integrated current collector disposed within the battery module, the integrated current collector electrically coupling the plurality of battery cells together.

In some embodiments, for each battery module, the at least one sensor of the module BMS includes at least one voltage sensor.

In some embodiments, for each battery module: the module BMS further includes a cell monitoring integrated circuit (IC); the cell monitoring IC is communicatively connected to the at least one voltage sensor; the cell monitoring IC is further communicatively connected to the general BMS; and the cell monitoring IC is configured for: converting sensor information received from the at least one voltage sensor into at least one voltage signal, and communicating the at least one voltage signal to the general BMS.

In some embodiments, for each battery module, the module BMS further includes at least one temperature sensor.

In some embodiments, the general BMS is configured to communicate with at least one powertrain component in response to a signal received by the general BMS from at least one module BMS of the plurality of the battery modules.

In some embodiments, the at least one powertrain component includes at least one of an inverter operatively connected to the battery pack; a charger operatively connected to the battery pack; and a DC-DC converter.

In some embodiments, the general BMS is configured to control a charging power level of the charger, based at least in part on the at least one voltage signal communicated to the general BMS from the cell monitoring IC of at least one of the battery modules.

In some embodiments, the general BMS is configured to supervise allowed operating zone operations of the plurality of battery cells of at least one battery module, based at least in part on the at least one voltage signal communicated to the general BMS from the cell monitoring IC of at least one of the battery modules.

In some embodiments, the general BMS is configured to perform at least one of: detecting a DC-DC converter status of the DC-DC converter; enabling the DC-DC converter; and disabling the DC-DC converter.

In some embodiments, for each battery module: the battery cells of the plurality of battery cells are arranged in a plurality of cell subgroups connected in series; and each cell subgroup of the plurality of cell subgroups includes a portion of the plurality of battery cells connected in parallel.

In some embodiments, for each battery module: the at least one sensor of the module BMS includes a plurality of voltage sensors; and a given voltage sensor of the plurality of voltage sensors is operatively connected to a corresponding cell subgroup of the plurality of cell subgroups, the given voltage sensor measuring the voltage of the corresponding one of the plurality of cell subgroups.

In some embodiments, for each battery module: the module BMS further comprises a plurality of balancing resistances; each balancing resistance of the plurality of balancing resistances is connected to a corresponding cell subgroup of the plurality of cell subgroups; and each balancing resistance of the plurality of balancing resistances is configured to selectively at least partially discharge the corresponding one of the plurality of cell subgroups.

In some embodiments, for each battery module, each balancing resistance of the plurality of balancing resistances includes: a plurality of resistors; and a switch operatively connected between the plurality of resistances and the corresponding cell subgroup of the plurality of cell subgroups.

In some embodiments, for each battery module, the general BMS is configured to control the plurality of balancing resistances for selectively causing at least one balancing resistance of the plurality of balancing resistor assemblies to at least partially discharge the corresponding cell subgroup of the plurality of cell subgroups.

In some embodiments, the battery pack further includes a plurality of communication wires communicatively connecting the module BMS of each battery module to the general BMS; and a plurality of wiring brackets for securing the plurality of communication wires in place in the battery housing.

In some embodiments, for each battery module, the module BMS includes at least one module transformer physical layer (module TPL) connector; the general BMS includes at least one general transformer physical layer (general TPL) connector; and the plurality of communication wires is connected between the at least one general TPL connector and the at least one module TPL connector of the module BMS of each of the plurality of battery modules.

The transformer physical layer provides electrical isolation between the general and module BMS boards, reducing the common mode voltage and increasing electromagnetic compatibility, which allows high-speed differential signaling between the module and general BMS.

In some embodiments, the battery housing includes a housing body, a first cover selectively connected to the housing body, a first chamber being defined between the housing body and the first cover, and a second cover selectively connected to the housing body on a side of the housing body opposite the first cover, a second chamber being defined between the housing body and the second cover; a first subgroup of the plurality of battery modules is disposed in the first chamber; and a second subgroup of the plurality of battery modules is disposed in the second chamber.

In some embodiments, the battery pack further includes a DC-DC converter disposed in the battery housing.

In some embodiments, the general BMS is operatively connected to the DC-DC converter, the general BMS being powered by the DC-DC converter.

In some embodiments, the general BMS is further communicatively connected to the DC-DC converter; and the general BMS is configured to manage operations of the DC-DC converter, the general BMS being configured for performing at least one of: detecting a fault condition of the DC-DC converter, enabling operations of the DC-DC converter, and disabling operations of the DC-DC converter.

In some embodiments, for each battery module, the module board includes a printed circuit board (PCB), the integrated current collector being formed at least in part by the PCB.

In some embodiments, for each battery module, each battery cell of the plurality of battery cells is connected to the integrated current collector via wire bonding.

In some embodiments, the battery pack further includes a plurality of bus bars electrically connecting in series the integrated current collectors of the plurality of battery modules.

In some embodiments, the general BMS further includes at least one of: at least one central processing unit (CPU); and at least one read-only memory (ROM).

In some embodiments, the battery pack further includes a battery disconnect unit (BDU) operatively connected to the general BMS, the general BMS being configured to manage operation of the BDU.

In some embodiments, the at least one read-only memory includes at least one electronically erasable programmable read-only memory (EEPROM).

In some embodiments, the BDU includes an insulation monitoring device (IMD) for monitoring electrical insulation resistance of a high voltage circuit, the high voltage circuit being formed at least in part by the battery pack; the general BMS is communicatively connected to the IMD; and the general BMS is configured to control battery pack operation based on signals received from the IMD.

In some embodiments, the BDU includes an insulation monitoring device (IMD) for monitoring electrical insulation resistance between the high voltage circuit and the vehicle chassis, the high voltage circuit being formed at least in part by the battery pack; the general BMS is communicatively connected to the IMD; and the general BMS is configured to control battery pack operation based on signals received from the IMD.

In some embodiments, the general BMS is further communicatively connected to a high voltage interlock (HVIL) for monitoring high voltage connections of the electric vehicle; the HVIL is at least partially connected to the BDU; and the general BMS is configured to control battery pack operation based on information received from the HVIL.

According to another aspect of the present technology, there is provided a method for managing a battery pack of an electric vehicle, the battery pack including a general battery management system (general BMS) operatively connected to a plurality of battery modules of the battery pack, each battery module including a module battery management system (module BMS), the method being executed by the general BMS. The method includes receiving, from at least one sensor of the module BMS of a given battery module of the plurality of battery modules, at least one operational indicator of the given battery module; and taking, based on the at least one operational indicator, at least one action relating to at least one battery pack component.

In some embodiments, receiving the at least one operational indicator includes receiving voltage data relating to a plurality of battery cells; the method further includes determining an imbalance in voltage between at least two subgroups of the plurality of battery cells of the given battery module; and taking the at least one action includes, causing at least one balancing resistance to discharge at least one subgroup of the plurality of battery cells.

In some embodiments, receiving the at least one operational indicator includes receiving at least one voltage reading from at least one voltage sensor.

In some embodiments, the method further includes determining that the at least one voltage reading represents a voltage of at least one cell of the battery module being outside of an allowed operating range.

In some embodiments, the general BMS manages a component of the module BMS in response to determining that the component voltage is outside of the allowed operating range.

In some embodiments, the method further includes detecting a fault condition in a DC-DC converter of the battery pack, the DC-DC converter being communicatively connected to the general BMS; and in response to detecting the fault condition, controlling at least one component of the DC-DC converter.

For the purposes of the present application, terms related to spatial orientation such as forward, rearward, front, rear, upper, lower, left, and right, are as they would normally be understood by a driver of the vehicle sitting therein in a normal driving position with the vehicle being upright and steered in a straight ahead direction. Specifically, the terms relating to spatial orientation should be understood as they would be understood when the presently described components are mounted to the vehicle, according to at least some embodiments.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a top, rear, left side perspective view of a battery pack according to non-limiting embodiments of the present technology;

FIG. 2 is a top, rear, right side perspective view of the battery pack of FIG. 1;

FIG. 3 is a perspective, partially-exploded view of portions of a powerpack including the battery pack of FIG. 1;

FIG. 4 is a top, rear, right perspective, partially-exploded view of the battery pack of FIG. 1;

FIG. 5 is a top, rear, right side perspective view of the housing covers and a housing body of the battery pack of FIG. 1;

FIG. 6 is a top, rear, left side perspective view of the battery pack of FIG. 1, with housing covers having been removed;

FIG. 7 is a left side elevation view of the battery pack with housing covers having been removed of FIG. 5;

FIG. 8 is a right side elevation view of the battery pack with housing covers having been removed of FIG. 5;

FIG. 9 is a perspective view of a battery module of the battery pack of FIG. 1, the battery module being shown in isolation;

FIG. 10 is a side elevation view of the battery module of FIG. 9;

FIG. 11 is a perspective, exploded view of the battery module of FIG. 9;

FIG. 12 is a close-up, partial, perspective view of the battery module of FIG. 9;

FIG. 13 is another close-up, partial, perspective view of the battery module of FIG. 9;

FIG. 14 is a close-up, top, left side, perspective view of an upper portion of the battery pack with housing covers having been removed of FIG. 5;

FIG. 15 is a close-up, left side elevation view of another portion of the battery pack with housing covers having been removed of FIG. 5;

FIG. 16 is a side elevation view of a general battery management system of the battery pack of FIG. 1, shown in isolation; and

FIG. 17 is a flowchart of a method of operating the battery pack of FIG. 1, according to non-limiting embodiments of the present technology.

It should be noted that, unless otherwise explicitly specified herein, the drawings are not necessarily to scale.

### DETAILED DESCRIPTION

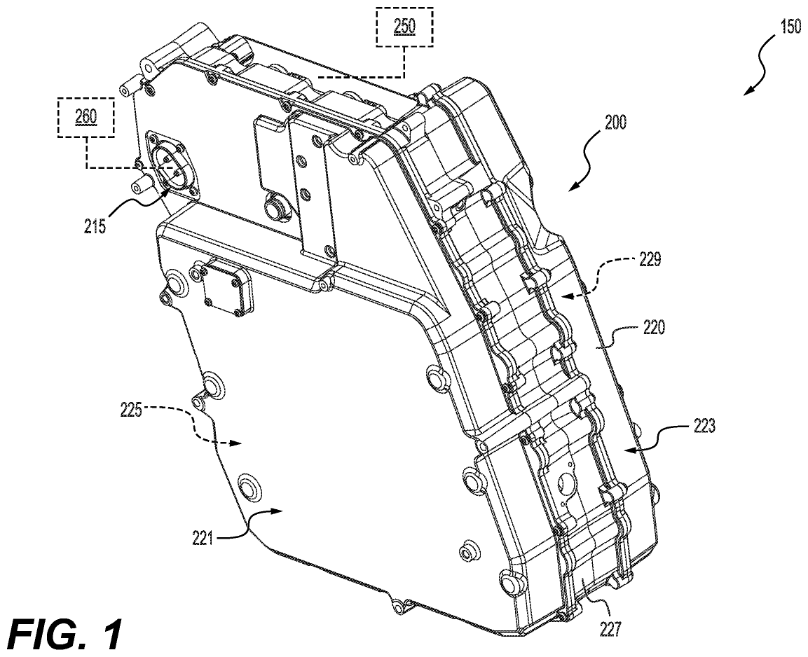

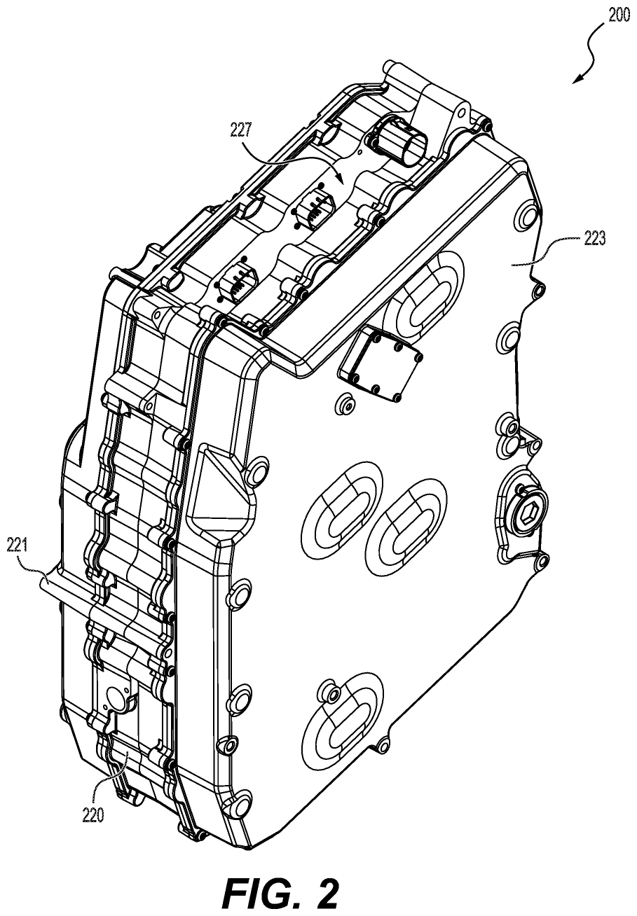

The present technology will be described herein with respect to a battery pack 200, illustrated in FIGS. 1 to 3, for powering an electric vehicle (not shown). The battery pack 200 could be implemented in a variety of vehicle types, including but not limited to two-wheeled straddle-seat electric vehicles (e.g. electric motorcycles, electric scooters), three-wheeled straddle-seat electric vehicles, electric snowmobiles, electric all-terrain vehicles (ATVs), electric side-by-side vehicles (SSVs), and four-wheeled electric vehicles.

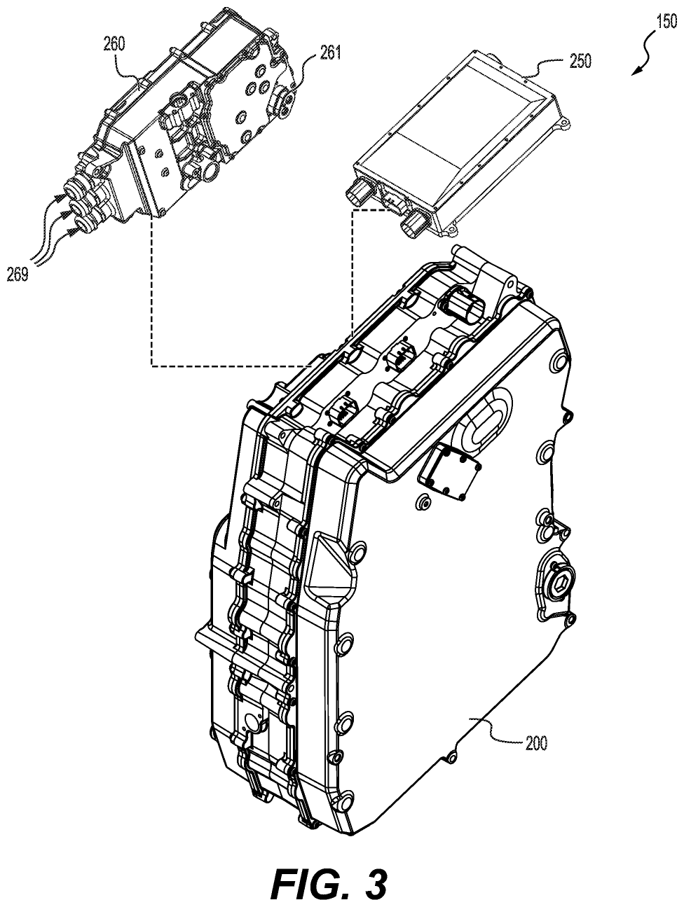

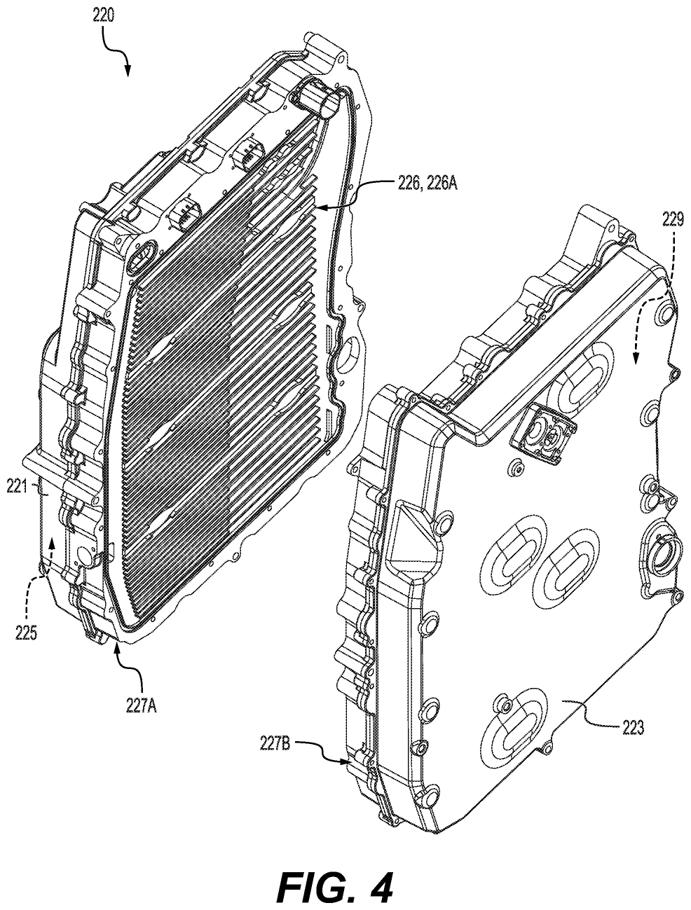

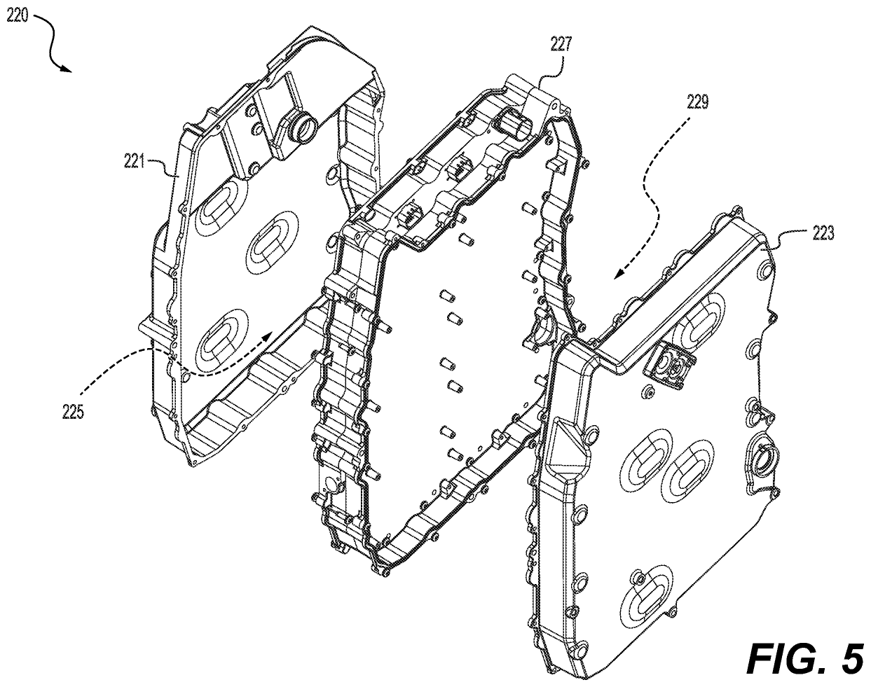

With additional reference to FIGS. 4 and 5, the battery pack 200 includes a battery housing 220. The battery housing 220 encloses different components of the battery pack 200 and provides connections for connecting to other vehicle components (FIG. 3, described further below). In the illustrated embodiment of the battery pack 200, the battery housing 220 (and the corresponding layout of components disposed therein) is shaped for use in a straddle-seat vehicle. In different embodiments of the present technology, it is contemplated that the battery housing 220 could be differently shaped. In some non-limiting examples, the battery housing 220 could be shaped for use in a vehicle having side-by-side seating or in four-wheeled electric vehicles having a passenger cabin.

The battery housing 220 includes a housing body 227, forming a center portion of the housing 220. As is illustrated in FIG. 4, the housing body 227 includes a left lateral portion 227A and a right lateral portion 227B connected together to form the body 227. In the illustrated embodiment the left and right lateral portions 227A, 227B are selectively connected together via threaded fasteners (not shown). It is contemplated that the left and right lateral portions 227A, 227B could be otherwise connected together in different manners. In the present embodiment, the housing body 227 is formed from aluminum, but could be formed from different materials, including but not limited to plastic or other metals.

The battery housing 220 includes a left side cover 221 selectively connected to the housing body 227, specifically selectively connected to the left lateral portion 227A. The housing 220 similarly includes a right side cover 223 selectively connected to the housing body 227, specifically selectively connected to the right lateral portion 227B. Each cover 221, 223 is selectively fastened to the housing body 227 to encase the components therein. It is contemplated that the covers 221, 223 could be selectively connected to the housing body 227 in different manners, including for example by tabs. A left chamber 225 is formed between the center portion of the housing body 227 and the left cover 221. A right chamber 229 is formed between the center portion of the housing body 227 and the right cover 223. The left and right chambers 225, 229 are shown in the exploded view of FIG. 5.

The battery housing 220 defines a battery cooling channel 226 therein, specifically through a center portion of the housing body 227. As can be seen in FIG. 4, the battery cooling channel 226 includes a plurality of fins extending inward from the housing 220. The battery cooling channel 226 is fluidly connected to a cooling system (not shown) of the vehicle. When the battery pack 200 is in operation in the vehicle, coolant fluid flows through the channel 226 along a longitudinal direction through the center of the housing body 227. In the present embodiment, the cooling channel 226 extends generally parallel to the covers 221, 223. An inner face of the left lateral portion 227A includes a first channel form 226A formed thereon and an inner face of the right lateral portion 227B includes a second channel form (not shown) formed thereon. The cooling channel 226 is then defined by the space created between the left and right lateral portions 227A, 227B.

As is partially illustrated in FIG. 3, the battery pack 200 is part of an electric powerpack 150 for powering the electric vehicle (not shown). In addition to the battery pack 200, the powerpack 150 includes a charger 250 connected to the battery pack 200. The charger 250 is mounted to the battery housing 220. Specifically, the charger 250 is fastened to the battery housing 220 and is disposed on a top side of the battery housing 220. It is contemplated that the location of the charger 250 relative to the battery pack 200 could vary.

The charger 250 is electrically connected to battery cells 230 of the battery pack 200 for supplying charge thereto; the battery cells 230 and the connection arrangement are described in more detail below. The charger 250 is configured to electrically connect to a socket (not shown) of the vehicle in which the battery pack 200 is installed for electrically connecting to an external power source for providing electricity to the charger 250 for charging the battery pack 200.

The powerpack 150 also includes an inverter 260 disposed on a left side of the battery pack 200. The inverter 260 is fastened to the battery housing 220, specifically along a left side of the battery housing 220. In some embodiments, it is contemplated that the inverter 260 could be disposed on a different location on the battery pack 200.

The inverter 260 includes an electric connector 261 disposed on an exterior of the invertor 260. The battery pack 200 includes an electric connector 215 electrically connected to battery cells 230 (described in more detail below). The electric connector 215 is disposed on an exterior of the battery housing 220, specifically on a left side of the housing 220. When the vehicle is in operation, the inverter 260 receives electric power from the battery cells 230 via the electric connector 215 and the electric connector 261.

The connector 215 is arranged to receive the connector 261 of the inverter 260, such that the electric connector 215 and the electric connector 261 are selectively connected together for managing electricity flow from the battery pack 200 to other electronic components of the vehicle via the inverter 260. In at least some embodiments, the inverter 260 is configured to electrically connect to a three-phase motor (not shown) via cables connected to three outlets 269 of the inverter 260. It is contemplated that the number of cables, type of electrical connection, and type of motor operatively connected to the inverter 260 could vary in different embodiments. While the inverter 260 connects directly to the battery pack 200 in the present embodiment, it is contemplated that the inverter 260 could be separated and spaced from the battery pack 200 and electrically connected to the battery cells 230 via cables or the like.

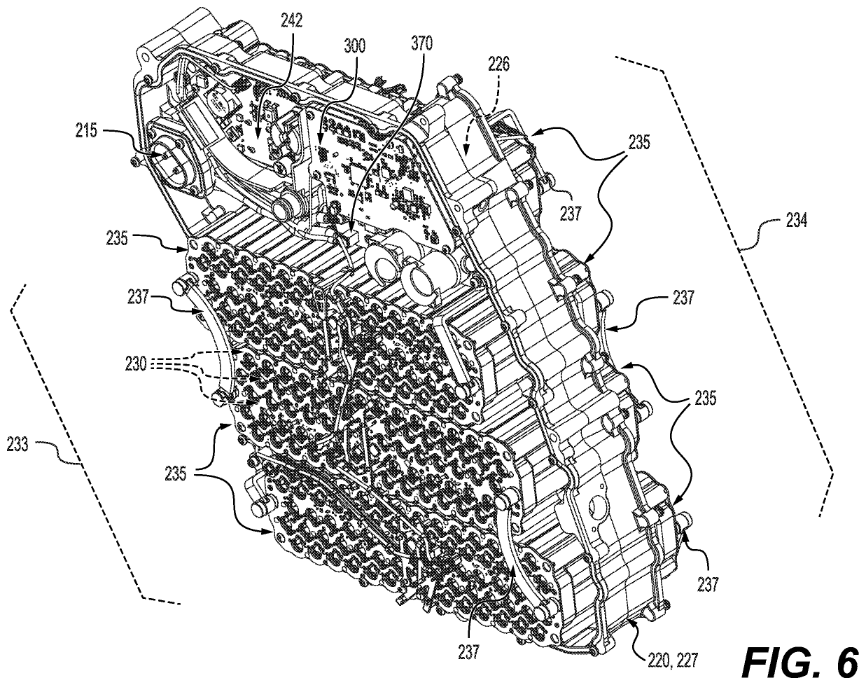

With reference to FIGS. 6 to 8, components of the battery pack 200 disposed inside the housing 220 are illustrated in more detail.

The battery pack 200 includes a plurality of battery modules 235 disposed in the battery housing 220. In the illustrated embodiment, the battery pack 200 includes seven modules 235. It is contemplated that different embodiments of the battery pack 200 could include more or fewer battery modules 235.

In the illustrate embodiment, the battery modules 235 are separated into two banks of modules: a left bank 233 having three modules 235 disposed in the left chamber 225 of the housing 220, and a right bank 234 having four modules 235 disposed in the right chamber 229. Depending on the embodiment, the left and right banks 233, 234 of modules 235 could include more or fewer modules 235. It is also contemplated that the left and right banks 233, 234 could have equal numbers of modules 235. The left bank 233 has fewer modules 235 than the right bank 234 in the present embodiment, but it is contemplated that the right bank 234 could have fewer modules 235 than the left bank 233.

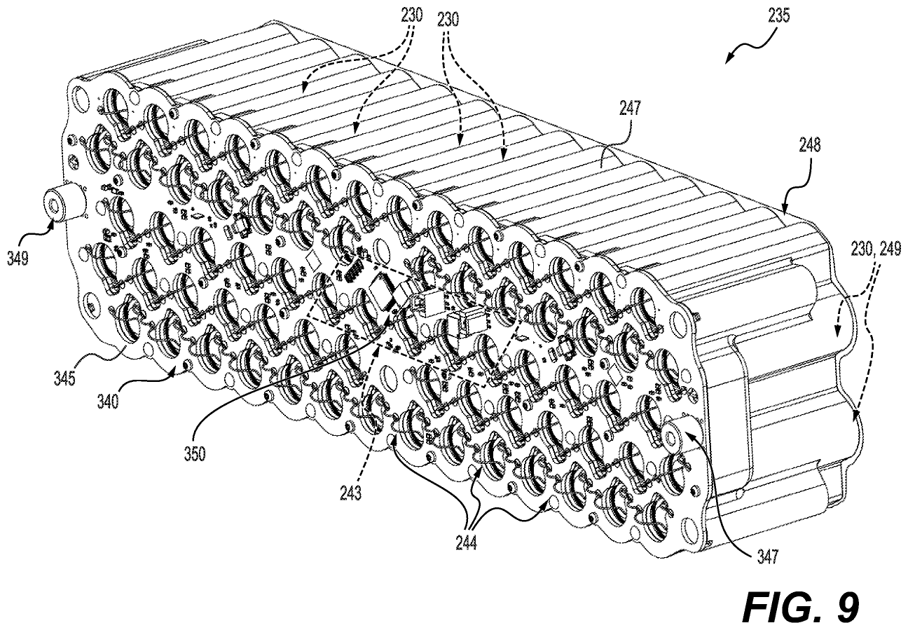

With additional reference to FIGS. 9 to 13, the battery modules 235 will be described in more detail. In the present embodiment, the modules 235 are generally identical and as such only one module 235 will be detailed. It is contemplated that differences between the battery modules 235 could be present in a given battery pack 200 in at least some embodiments.

Each battery module 235 includes a plurality of battery cells 230. In the illustrated embodiment, each module 235 includes seventy battery cells 230. The battery pack 200 thus has a total of 490 (four hundred ninety) battery cells 230. It is contemplated that each battery module 235 could include more or fewer battery cells 230. Depending on the number of battery cells 230 in each module 235 and/or the total number of modules 235 in a given embodiment, it is also contemplated that the total number of battery cells 230 in the battery pack 200 could vary.

The battery cells 230 are cylindrical battery cells 230. In the present embodiment, the battery cells 230 are 3.6V cylindrical cells, such as LG™ M50L lithium ion cells in 21700 format, but it is contemplated that different versions of cells could be used in some embodiments. For example, battery cells could vary in nominal energy capacity, usable energy capacity, discharge rate, cell chemistry and cell type.

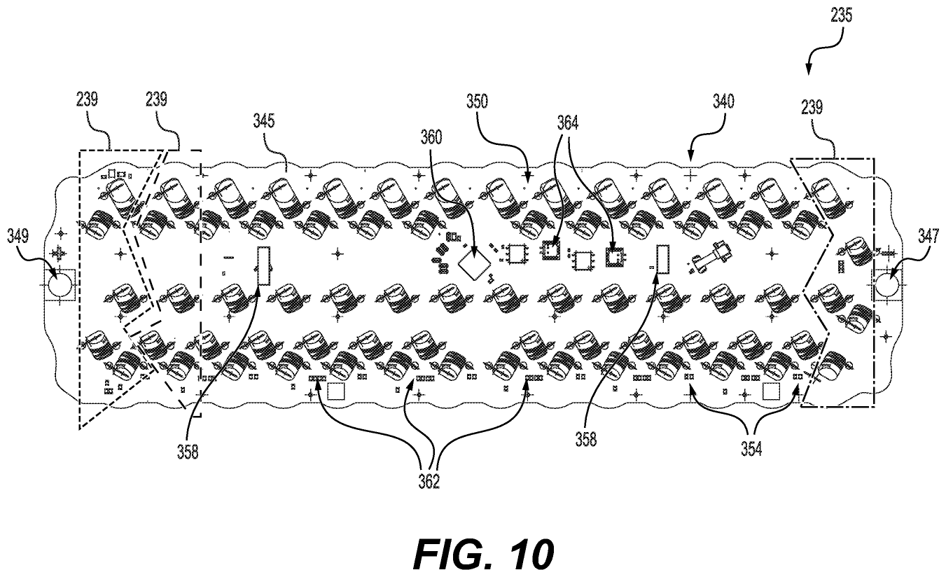

The battery cells 230 of each module 235 are electrically arranged in a plurality of cell subgroups 239, which are connected in series with each other. Three such subgroups 239 are illustrated schematically in FIG. 10. Within each subgroup 239, the battery cells 230 are connected to one another in parallel. In the present embodiment, each module 235 has fourteen cell subgroups 239, with each cell subgroup 239 being formed from five battery cells 230 connected in parallel. Depending on the particular embodiment, the number of subgroups 239 and/or the number of battery cells 230 in each subgroup 239 could vary. Use of the subgroups 239 within each module 235 is described in more detail below.

Each module 235 includes a support matrix 247 for supporting the battery cells 230. The support matrix 247 is formed from a rigid, electrically isolating material, specifically a rigid plastic in the present embodiment. The matrix 247 defines therein seventy generally cylindrical cavities 249 for receiving the battery cells 230 in the support matrix 247. In the illustrated embodiment, the support matrix 247 is formed such that the seventy battery cells 230 of each module 235 are arranged in five parallel rows of fourteen cells 230. It is contemplated that the particular physical distribution in each module 235 could vary. In embodiments where different size formats of cylindrical cells are used, it is contemplated that the matrix 247 could be sized and shaped to receive the different battery format therein.

The battery modules 235 are arranged such that a long axis of each cylindrical battery cell 230 extends generally orthogonally to the center portion of the housing body 227 and the lateral outer surfaces of the left and right side covers 221, 223. Inner ends of the cells 230 (closer to the housing body 227) are affixed to and sealed in the support matrix 247 by epoxy 246. Outer ends of the battery cells 230 (closer to the covers 221, 223) are restrained by an outer end 247A of the matrix 247, although it is contemplated that other structures could be utilized to maintain the battery cells 230 in the support matrix 247 in different embodiments.

Each module 235 includes a module board 340 electrically connected to the battery cells 230 of the module 235. The module board 340 includes a module battery management system (module BMS) 350 for managing operation of the battery module 235, in conjunction with a general battery management system (general BMS) 300 of the battery pack. Broadly, the general BMS 300 is disposed in the battery housing 220 and is communicatively connected to each module board 340 of the battery modules 235. Both the module BMS 350 and the general BMS, and components thereof, are described in more detail further below. The module board 340 also includes an integrated current collector 345 disposed within the battery module 235. The integrated current collector 345 electrically couples the battery cells 230 together.

In the present embodiment, the module board 340 thus serves to both collect current from the battery cells 230 and to monitor operating conditions of the battery cells 230 (in conjunction with the general BMS 300). In the present embodiment, the module board 340 is fastened to the support matrix 247. The module board 340 could be differently supported in the module 235, depending on the embodiment.

As is noted above, the integrated current collector 345 of the module board 340 is electrically connected to the battery cells 230. Specifically, the integrated current collector 345 is configured to collect current from the battery cells 230 of the corresponding module 235 when the battery pack 200 is powering the vehicle and inversely for distributing electrical power to each battery cell 230 in the corresponding battery module 235 when the battery pack 200 is charging. In the current embodiment, the integrated current collector 345 is formed from a printed circuit board (PCB) 345 sized and arranged to cover an external side of the corresponding module 235.

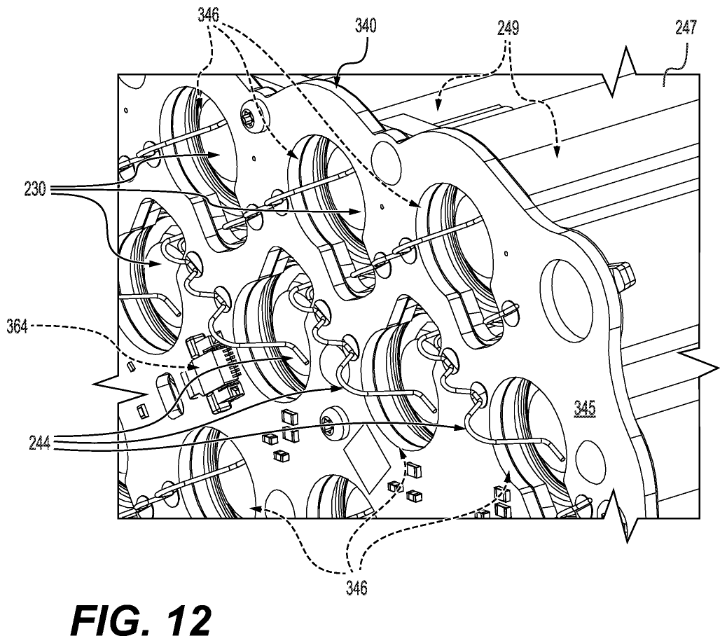

As is illustrated in more detail in FIG. 12, the battery cells 230 are connected to the PCB 245 via wire bonding. The integrated current collector/PCB 345 of the module board 340 defines a plurality of apertures 346 therein to allow electrical connection of the battery cells 230 to the module board 340/PCB 345. The module board 340 includes a plurality of wire bonds 244 for connecting the battery cells 230 to the PCB 345, and in turn connecting the battery cells 230 together in series/parallel as mentioned above. Each wire bond 244 connects an outer perimeter of one battery cell 230 (the negative terminal) to an inner portion of a neighboring battery cells 230 (the positive terminal). The apertures 346 in the PCB 345 are shaped to allow connection to the negative terminal of each battery cell 230 at a specific location, and otherwise covers remaining portions of the negative terminal. The apertures 346 in the PCB 345 generally leave the positive terminals of each battery cell 230 exposed, but it is contemplated that portions of the positive terminal could be partially covered by the PCB 345 as well.

Each bank 233, 234 of battery modules 235 is electrically connected together in series by a plurality of bus bars 237 to collect current from each module 235. The three PCBs 345 of the left bank 233 are electrically connected to one another in series via the bus bars 237 and the four PCBs 345 of the right bank 234 are electrically connected to one another in series via the bus bars 237. The two banks 233, 234 are connected together through a connecting bus bar 236 extending through the housing 220. The specific placement and forms of the bus bars 236, 237 could vary, depending on the particular embodiment.

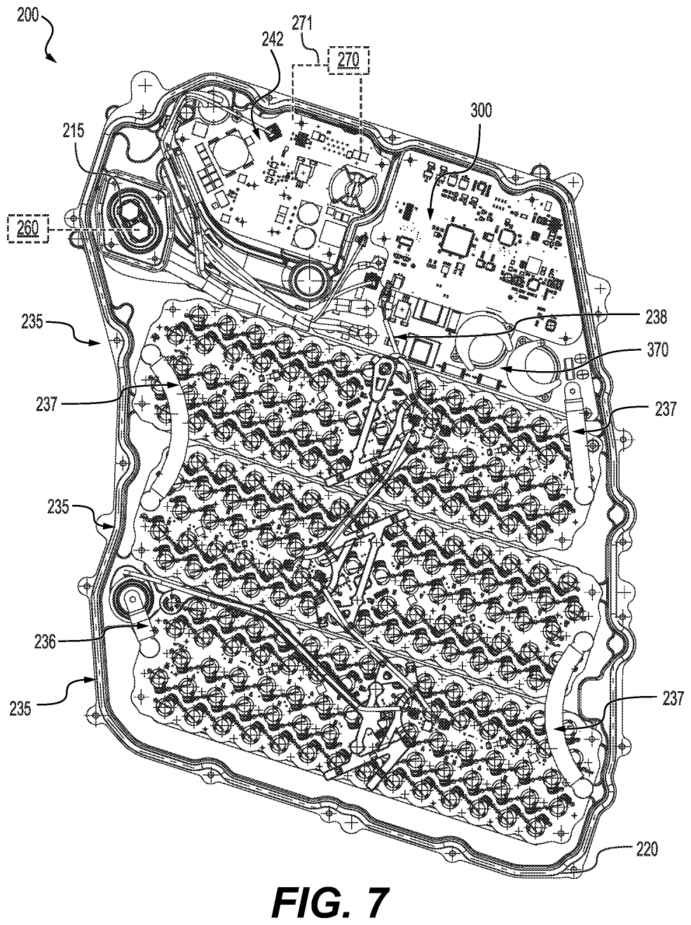

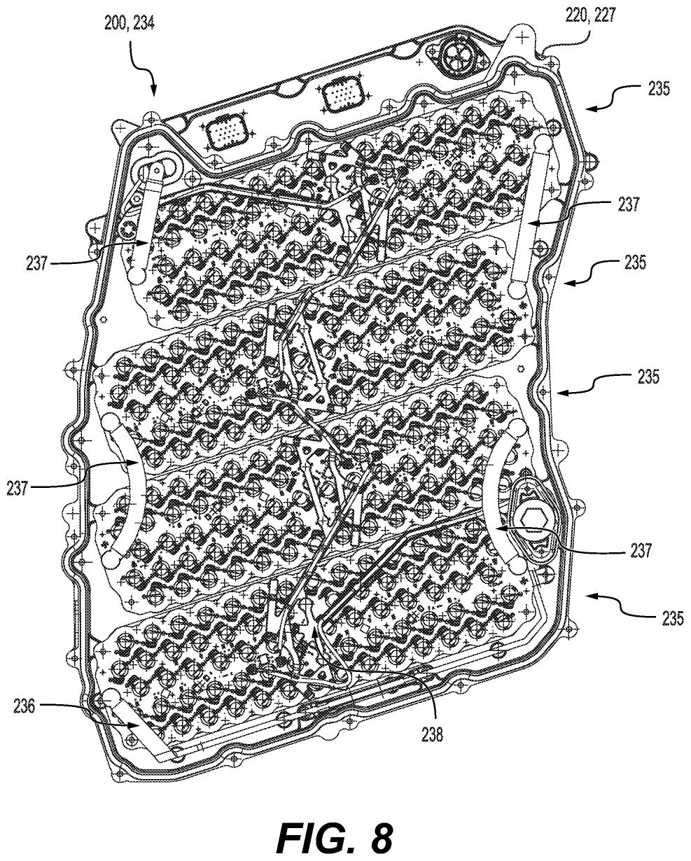

Each PCB 345 includes a positive board terminal 347 and a negative board terminal 349. The bus bars 237 connect the positive board terminal 347 of a given module 235 to the negative board terminal 349 of a neighboring module 235. As can be seen from FIGS. 7 and 8, the battery modules 235 of each bank 233, 234 are arranged in alternating orientations, such that the positive board terminal 347 of one module 235 is disposed on a same side of the housing 220 as the negative board terminal 349 of the neighboring module board 340. The bus bar 237 connecting these two modules 235 thus does not generally need to extend across the width of the modules 235. The connecting bus bar 236 extending through the housing 220 also connects to the positive board terminal 347 of one of the modules of the banks 233,234 and the negative board terminal 349 of one of the modules of one of the banks 233, 234.

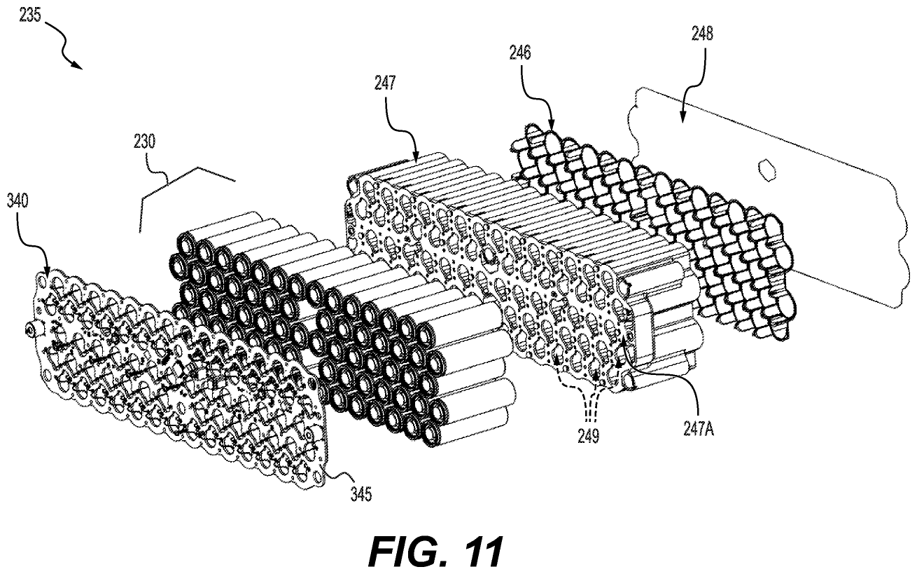

Each battery module 235 further includes a dielectric layer 248 disposed inward of the inner ends of the battery cells 230 and bonded to the cells 230 and the matrix 247 by the epoxy layer 246. As can be seen in FIG. 11, the dielectric layer 248 forms an inner most surface (with respect to the orientation of the module 235 mounted in the housing 220) of the module 235. When each module 235 is installed in the battery pack 200, the dielectric layer 248 forms an insulating layer to electrically isolate the battery cells 230 from the housing body 227. In the illustrated embodiment, the dielectric layer 248 is formed by a sheet of electrical insulation paper, although different materials could be used.

It is contemplated that in some embodiments, the battery pack 200 could include one dielectric layer disposed between inner ends of the battery cells 230 of the left bank 233 of modules 235 and the housing body 227 and another dielectric layer disposed between inner ends of the battery cells 230 of the right bank 234 of modules 235 and the housing body 227. In such an embodiment, for instance, the dielectric layers could be applied to a majority or an entirety of inner faces of the housing body 227.

The cooling channel 226, disposed in the center portion 227 of the housing 220 as is described above, is in thermal communication with banks of battery cells 230 disposed on both a right side of the channel 226 and a left side of the channel 226. Specifically, inner ends of the battery cells 230 of each bank 233, 234 are in thermal communication with the cooling channel 226 through the housing body 227. When in operation, coolant flowing through the battery cooling channel 226 absorbs heat from inner ends of the battery cells 230 on each lateral side of the battery cooling channel 226. The dielectric layers 248 of the modules 235 electrically insulate the housing body 227, while permitting heating to flow from the battery cells 230 to the coolant in the cooling channel 226.

In order to contain the electrical energy stored in the battery modules 235, the battery housing 220, the left and right covers 221, 223, enclosing each module board 340 and outer ends of the battery cells 230, are electrically insulated from the modules 235. In the present embodiment, the left and right covers 221, 223 are spaced from the modules 235 and the module boards 340. In different embodiments, it is contemplated that additional materials or components could be implemented to electrically insulate the left and right covers 221, 223 from the battery modules 235.

With continued reference to FIG. 10, the module BMS 350 of each module board 340 is formed from a plurality of components disposed on and connected to the PCB 345. The module BMS 350 includes, inter alia, sensors for monitoring operating conditions and sensing operating conditions of the corresponding module 235.

The module BMS 350 includes a plurality of voltage sensors 354 for sensing a voltage across at least a portion of the battery cells 230. As is mentioned above, the battery cells 230 are arranged in fourteen cell subgroups connected in series, each subgroup 239 being formed from five battery cells 230 connected in parallel. In the present embodiment, the module BMS 350 includes fourteen voltage sensors 354, one for each of the cell subgroups 239. Each voltage sensor 354 is operatively connected to a corresponding cell subgroup 239 for measuring the voltage of the corresponding cell subgroup 239. While the voltage sensor 354 of each subgroup 239 cannot provide the voltage of each battery cell 230 of the subgroup 239, the voltage sensor 354 determines an equivalent cell voltage across the five battery cells 230 connected in parallel. As will be understood by a person of the art, battery cells 230 connected in parallel will generally passively balance each other; voltage over the five parallel battery cells 230 will thus generally be the same as the voltage of each battery cell 230 of the parallel group.

The module BMS 350 also includes a plurality of balancing resistances 362. Each of the subgroups 239 is electrically connected to one or more of the plurality of balancing resistances 362 for selectively discharging (to reduce the voltage thereof) of one or more of the cell subgroups 239. In the present embodiment, each cell subgroup 239 is connected to a corresponding one of the balancing resistances 362, with each balancing resistance 362 being configured to selectively draw current therethrough from and at least partially discharge the correspond cell subgroup 239. In the illustrated embodiment, the resistances 362 are specifically groups of resistors 362. The module BMS 350 further includes switches (not shown) operatively connected between the balancing resistances 362 and the corresponding cell subgroup 239 in order to control the selective discharge one any given cell subgroup 239. As will be described further below, the switches are communicatively connected to the general BMS 300 in order to receive direction to open and close, permitting the general BMS 300 to manage charge balance between different cell subgroups 239 of a given module 235, or between different battery modules 235.

In the present embodiment, the module BMS 350 further includes temperature sensors 358. In the present embodiment, the module BMS 350 includes two temperature sensors 358 operatively connected to the PCB 345. The two temperature sensors 358 are disposed on opposite sides of the PCB 345. It is contemplated that the module BMS 350 could include more or fewer temperature sensors 358 in different locations. In some embodiments, the temperature sensors could be omitted from the module BMS 350 of one or more of the battery modules 235. In at least some embodiments, the temperature sensors could be omitted from every module BMS 350. In order to monitor the temperature of the battery pack 200 in such an embodiment, it is contemplated that an external temperature sensor, in thermal communication with the battery pack 200, could be included in the vehicle. For instance, a temperature sensor in thermal communication with coolant flowing through the cooling channel 226.

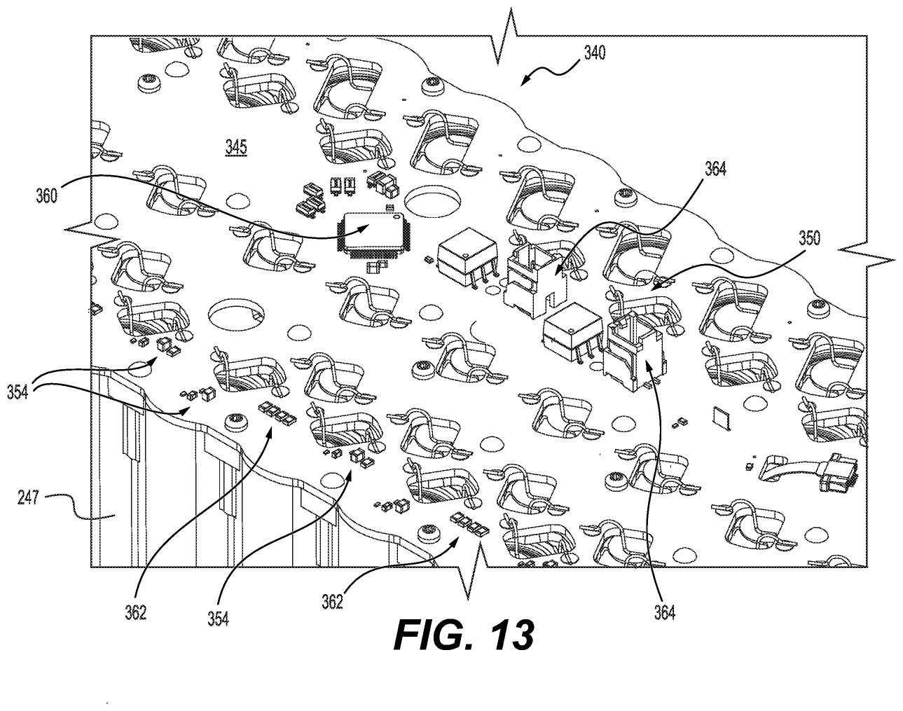

With continued reference to FIG. 10 and additional reference to FIG. 13, the module BMS 350 includes a cell monitoring integrated circuit (IC) 360 for processing signals produced and received by the module BMS 350. The cell monitoring IC 360 is communicatively connected to voltage sensors 354 for receiving information (signals) therefrom. Specifically, the cell monitoring IC 360 is configured for converting sensor information received from the voltage sensors 354 into one or more voltage signals.

In the present embodiment, the voltage signals converted from information received from the voltage sensors 354 can be communicated from the cell monitoring IC 360 to the general BMS 300. To this end, the module board 340 includes two module transformer physical layer (module TPL) connectors 364. It is contemplated that more or fewer connectors 364 could be included in certain embodiments. Each module TPL connectors 364 receives therein a communication wire for communicatively connecting the module BMS 350, and more specifically the cell monitoring IC 360, to the general BMS 300. In at least some embodiments, it is also contemplated that the cell monitoring IC 360 could be configured for converting temperature information received from the temperature sensors 358 into one or more temperature signals and communicating the one or more temperature signals to the general BMS 300.

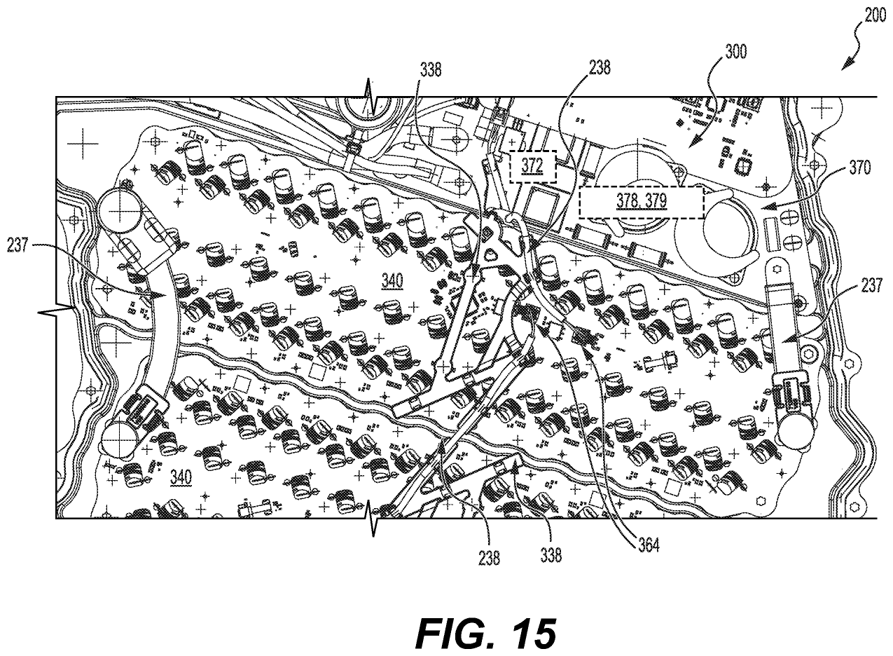

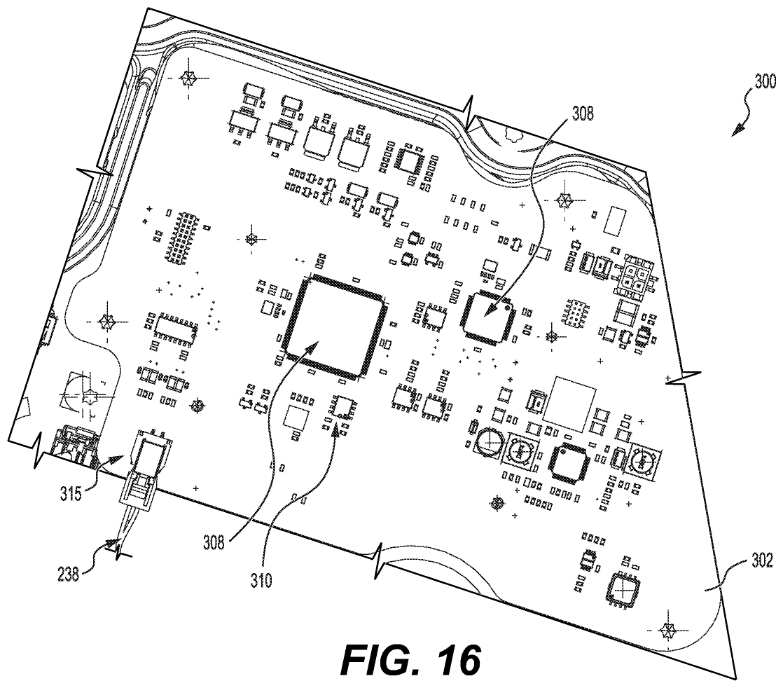

The battery pack 200 includes communication wires 238 communicatively connecting the module BMS 350 of each battery module 345 to the general BMS 300. As can be seen in additional detail in FIG. 15, the battery pack 200 further includes wiring brackets 338 for securing the communication wires 238. The brackets 338 aid in securing the communication wires 238 in place in the battery housing 220, in addition to spacing the communication wires 238 from surfaces of the PCBs 345 over which the communication wires 238 extend. The communication wires 238 are connected between a general TPL connector 315 of the general BMS 300 (FIG. 16) and the module TPL connectors 364 of the module BMS 350 of each of the battery modules 235.

With reference to FIGS. 6, 7, and 14, the battery pack 200 also includes a DC-DC converter 242 operatively connected to a twelve volt battery 270 (shown schematically in FIG. 7). It is contemplated that the DC-DC converter 242 could be arranged exterior to the battery pack 200 in at least some embodiments, and simply connected to the battery pack 200. In the present embodiment, the DC-DC converter 242 is disposed in the left chamber 225 of the battery pack 200. The DC-DC converter 242 is electrically connected to battery modules 235, via a battery disconnect unit board (BDU board) 370 (described below) and the general BMS 300, in order to receive electricity therefrom. The DC-DC converter 242 is communicatively and operatively connected to the general BMS 350. The general BMS 300 is configured to control or manage operations of the DC-DC converter 242. The DC-DC converter 242 is arranged to provide power from the battery cells 230 to a low voltage circuit 271 (shown schematically in FIG. 7) in order to power different electrical components of the vehicle (other than the inverter 260) that operate at a lower voltage. In the present embodiments, the low voltage circuit 271 provides power to charge the twelve volt battery 270, the BDU board 370, and the general BMS 300. Additionally, the low voltage circuit 271 could further provide power to front and rear lights, navigation systems, on-board control units, dashboard displays, and sound systems.

With additional reference to FIG. 16, the general battery management system (general BMS) 300 of the battery pack 200, and components thereof, will be described in more detail. As was mentioned briefly above, the general BMS 300 manages operation of the battery pack 200 and the battery modules 235 in conjunction with module BMS 350 of each battery module 235. The general BMS 300, also referred to as a global BMS 300, is configured for performing a variety of general management tasks for operating the battery pack 200, described in more detail below.

The general BMS 300 is formed in part by a printed circuit board (PCB) 302, upon which electronic and electrical components of the general BMS 300 are disposed and connected. Depending on the embodiment, it is contemplated that components of the general BMS 300 could be secured to two or more PCBs 302.

The general BMS 300 includes at least one central processing unit (CPU) 308 for processing data, producing control signal for managing components, and accessing stored instructions. In the illustrated embodiment, the general BMS 300 includes two CPUs 308. In different embodiments, the general BMS 300 could include only one or more than two CPUs 308. The general BMS 300 also includes read-only memory (ROM) 310, to which instructions and data are stored. In the present embodiment, the read-only memory 310 includes electronically erasable programmable read-only memory (EEPROM) 310. Depending on the embodiment, the read-only memory 310 could include additional, or alternative, memory structures.

The general BMS 300 further includes additional components for standard operations of the general BMS and the battery pack 200, the specifics of which could vary in different embodiments. The additional components of the general BMS 300 could include, but are not limited to: isolators, drivers, and processors.

As is noted above, during operation of the battery pack 200, the general BMS 300 is configured to receive one or more voltage signals from the cell monitoring IC 360, the voltage signals having been converted from sensor information received from the voltage sensors 354 by the cell monitoring IC 360. The general BMS 300 is further configured to communicate with and/or manage operation of one or more of the powertrain components present in the electric vehicle. In at least some cases, the general BMS 300 is configured to communicate with and/or modulate operation of the powertrain components in response to a signal received by the general BMS 300 from the module BMS 350 of one or more of the battery modules 235. For instance, in response to signals received thereby, the general BMS 300 could manage operation of one or more of: the inverter 260, the charger 250, and the DC-DC converter 242. In some cases, the general BMS 300 is configured to perform detecting a DC-DC converter status of the DC-DC converter 242, enabling the DC-DC converter 242, and/or disabling the DC-DC converter 242.

In at least some embodiments, the general BMS 300 is also configured to generally monitor charging activity of the charger 250, the general BMS 300 being communicatively and operatively connected to the charger 250. In some cases, the general BMS 300 could monitor activities of the charger 250 based at least in part on the voltage signals communicated to the general BMS 300 from the cell monitoring IC 360 of one or more battery modules 235. For example, the general BMS 300 could be configured to monitor a charge level of each battery module 235 and modulate the charging of the battery cells 230 by the charger 250. Depending on the embodiment, it is contemplated that the general BMS 300 could: measure instantaneous voltage and current in the circuit of the battery pack 200; track an overall quantity of current flowing into and/or out of the battery pack 200; and track voltage values of the battery pack 200 over time. In at least some embodiments, a state of charge could be determined by a computer-implemented device of the vehicle.

In at least some embodiments, the general BMS 300 could additionally or alternatively be configured to supervise allowed operating zone operations of the battery cells 230. For instance, the general BMS 300 could be configured to supervise allowed operating zone operations of the battery cells 230 based at least in part on the voltage signals communicated to the general BMS 300 from the cell monitoring IC 360 of one or more battery modules 235. The operating zone of the battery cells 230 is generally defined by temperature and a charging or discharging rate; the specific values for the operation zone controls will vary depending on the particular embodiment.

As is noted above, the module BMS 350 of each battery module 235 includes balancing resistances 362 for selectively discharging a corresponding one of the cell subgroups 239. The general BMS 300 is operatively and communicatively connected to switches of each balancing resistances 362. For each battery module 235, the general BMS 300 is thus configured to control the balancing resistances 362 for selectively causing one or more balancing resistances 362 to at least partially discharge the corresponding cell subgroup 239. The general BMS 300 is configured to send instructions to the module BMS 350 to open and close one or more of the switches.

In some cases, the general BMS 300 sends instructions in response to voltage signals received from the module BMS 350 of one or more battery modules 235. For example, upon determining, by the general BMS 300, that a given one of the subgroups 239 has a greater voltage than other subgroups 239 of the same battery module 235, the general BMS 300 could direct the balancing resistance 362 of the given subgroup 239 to partially discharge the given subgroup 239. The general BMS 300 could further direct the balancing resistances 362 of all or a plurality of subgroups 239 in one of the battery modules 235 to at least partially discharge their corresponding battery cells 230, in order to balance voltages across the battery modules 235.

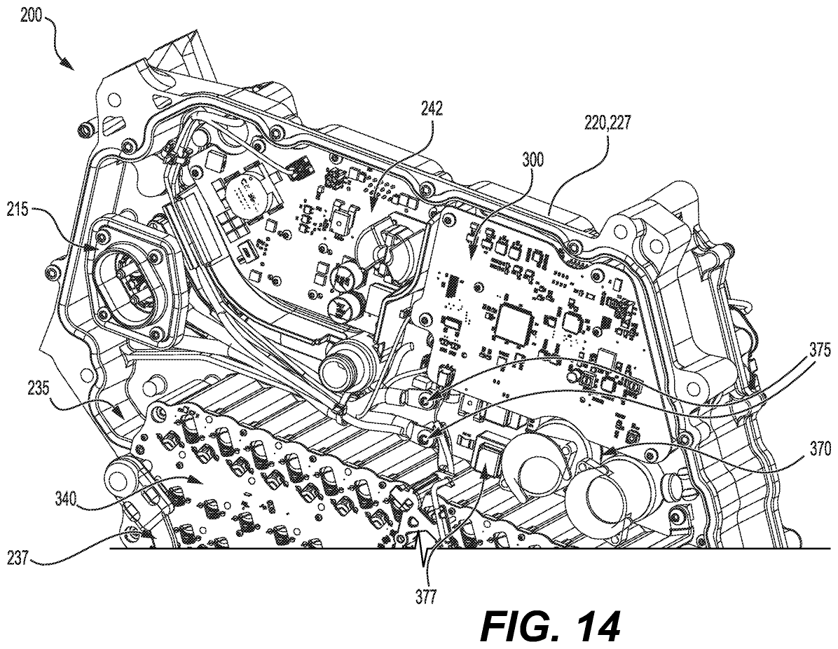

With reference to FIGS. 14 and 15, the battery pack 200 further includes a battery disconnect unit board (BDU board) 370. In the present embodiment, portions of the BDU board 370 are disposed between the general BMS 300 and the center portions of the housing body 227, and generally parallel thereto.

The BDU board 370 is operatively and communicatively connected to the general BMS 300. The BDU board 370 includes a BDU board controller 372 (shown schematically) which is communicatively connected to the general BMS 300, the BDU board 370 being communicatively connected directly to the general BMS 300. It is contemplated that all or some of the components of the BDU board 370 could be incorporated into the general BMS 300 and/or that the BDU board 370 and the general BMS 300 could be integrally connected. The general BMS 300 is configured to manage operation of various components of the BDU board 370, described further below.

In the illustrated embodiment, the BDU board 370 include two high voltage contactors 375. The high voltage contactors 375 are connected in series to the bus bars 237 and connected to the electric connector 215. Power drawn from the battery cells 230 is collected by the module PCBs 345, gathered by the bus bars 237, and then provided to the inverter 260 via the electric connector 215 via the BDU board 370. By passing the high voltage battery circuit through the BDU board 370, the BDU board 370 is arranged to interrupt the high voltage current flow when directed by the general BMS 300 or in response to signals from the BDU board controller 372.

The BDU board 370 also includes an insulation monitoring device (IMD) 378 (shown schematically) for monitoring electrical insulation resistance of a high voltage circuit of the vehicle. In the present case, the high voltage circuit is formed at least in part by the battery pack 200, and more specifically the circuit formed in part by the module PCBs 345 and the bus bars 236, 237. The general BMS 300 is communicatively and operatively connected to the IMD 378. The general BMS 300 is configured to operate the battery pack 200 based on signals received from the IMD 378. For example, while the vehicle is not being actively ridden, the general BMS 300 could end or temper current flowing from the battery modules 235 in response to receiving a signal from the IMD 378 that a fault may have occurred in the high voltage circuit. Generally, the IMD 378 provides a digital value of insulation resistance to the general BMS 300. Depending on the specific embodiment, steps such as limiting power drawn from the battery cells 230 can then be taken based on one or more thresholds, including but not limited to insulation values and time gradients of insulation values.

The electric vehicle, according to present embodiments, includes a high voltage interlock (HVIL) 379 (shown schematically on the BDU board 370) for monitoring high voltage connections of the electric vehicle. The HVIL 379 is at least partially connected to the BDU board 370 and the general BMS 300 is further communicatively connected thereto. The general BMS 300 and the BDU board 370 are further configured to affect operation of the battery pack 200 based on the open or closed state of the HVIL 379. When the HVIL 379 state changes from the closed to the open state, due to a high voltage connector becoming unmated for example, the general BMS 300 will take action in order to attempt avoiding exposure of a vehicle user to a dangerous electrical current from the energized high voltage circuit, which is now potentially exposed due to the HVIL 379 state changing.

The BDU board 370 further includes two precharge circuits 377 (only one shown) operatively and communicatively connected to the general BMS 300 and the battery modules 235. Each precharge circuit 377, each for one pole, is formed from a contactor and a resistor in series. It is contemplated that only one precharge circuit 377 may be included in some embodiments. It is also contemplated that additional components could be included in the precharge circuits 377, for example additional resistors. During initial powering up of the battery pack 200, the general BMS 300 can direct one or both precharge circuits 377 to close their corresponding contacts in order to dampen initial current spikes, referred to as “inrush current”, that may arise.

While not explicitly illustrated, the BDU board 370 further includes a global current sensor for reading the current flowing in/out of the battery pack 200 as a whole and a global voltage sensor for reading the voltage of the battery pack 200 as a whole. Each of the global current sensor and the global voltage sensor are communicatively connected to the general BMS 300, in order to provide the current and voltage information thereto.

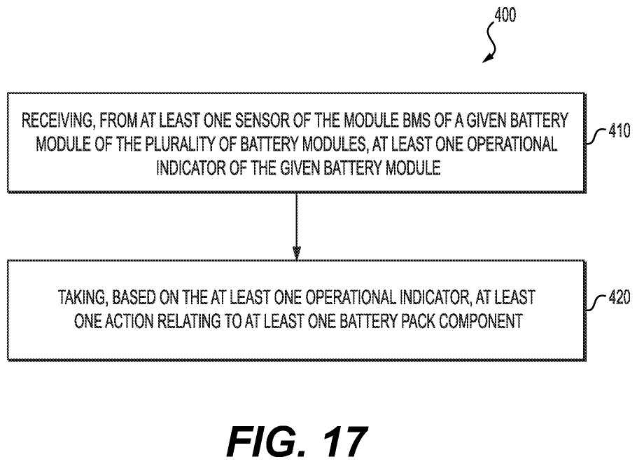

With reference to FIG. 17, a method 400 for managing the battery pack 200 of the electric vehicle is illustrated. The method 400 is executed by the general BMS 300, more specifically the CPUs 308 of the general BMS 300.

The method 400 begins, at step 410, with receiving, from at least one sensor of the module BMS 350 of a given battery module 235, at least one operational indicator of the given battery module 235.

In some cases, receiving the at least one operational indicator includes receiving voltage data relating to the battery cells 230. For instance, the operational indicator could be one or more voltage readings from one or more of the voltage sensors 354 of one or more of the battery modules 235. In some such cases where the general BMS 300 receives voltage data relating to the battery cells 230, the method 400 could further include determining an imbalance in voltage between two or more cell subgroups 239 of one of the battery modules 235.

The method 400 then continues, at step 420, with taking one or more actions relating to one or more components of the battery pack 200, the actions being based on the operational indicators.

In response to receiving voltage signals relating to the battery cells 230 or one or more of the battery modules 235, the method 400 could include communicating with one or more of the powertrain components. For instance, the method 400 could include sending control signals to modulate operation of one or more of: the inverter 260, the charger 250, and the DC-DC converter 242. In some cases, for example, the method 400 could include detecting a DC-DC converter status of the DC-DC converter 242, enabling the DC-DC converter 242, and/or disabling the DC-DC converter 242.

In at least some embodiments, taking the at least one action could include causing one or more of the balancing resistances 362 to discharge one or more subgroups 239 of the battery cells 230. In some cases, the method 400 could additionally or alternatively include directing the balancing resistances 362 of one or more battery modules 235 to at least partially discharge the battery cells 230 therein.

In at least some embodiments, the method 400 further includes determining that the voltage readings represent a voltage of one or more of the battery cells 230 being outside of an allowed operating range. In some such cases, the method 400 could include managing, by the general BMS 300, a component of the module BMS 350 of one or more battery modules 235 in response to determining that the voltage signal is outside of the allowed operating range.

In at least some embodiments, the method 400 could further detect a fault condition in the DC-DC converter 242. In such an embodiment, the method 400 could continue with controlling at least one component of the DC-DC converter 242 in response to detecting the fault condition. For instance, the method 400 could include causing, by the general BMS 300, the DC-DC converter to disable operations in response to detecting the fault condition.

The battery pack 200 and the method 400 implemented in accordance with some non-limiting embodiments of the present technology can be represented as follows, presented in numbered clauses.
CLAUSE 1. A battery pack for an electric vehicle, the battery pack comprising:
a battery housing;
a general battery management system (general BMS) disposed in the battery housing; and
a plurality of battery modules disposed in the battery housing, each battery module of the plurality of battery modules comprising:
   a plurality of battery cells; and
   a module board comprising:
   a module battery management system (module BMS) communicatively connected to the general BMS, the module BMS including at least one sensor for sensing at least one operating condition of the plurality of battery cells; and
   an integrated current collector disposed within the battery module, the integrated current collector electrically coupling the plurality of battery cells together.
CLAUSE 2. The battery pack of clause 1, wherein, for each battery module, the at least one sensor of the module BMS includes at least one voltage sensor.
CLAUSE 3. The battery pack of clause 2, wherein, for each battery module:
the module BMS further comprises a cell monitoring integrated circuit (IC);
the cell monitoring IC is communicatively connected to the at least one voltage sensor;
the cell monitoring IC is further communicatively connected to the general BMS; and
the cell monitoring IC is configured for:
converting sensor information received from the at least one voltage sensor into at least one voltage signal, and
communicating the at least one voltage signal to the general BMS.
CLAUSE 4. The battery pack of clause 2, wherein, for each battery module, the module BMS further comprises at least one temperature sensor.
CLAUSE 5. The battery pack of clause 3, wherein the general BMS is configured to communicate with at least one powertrain component in response to a signal received by the general BMS from at least one module BMS of the plurality of the battery modules.
CLAUSE 6. The battery pack of clause 5, wherein the at least one powertrain component includes at least one of:
an inverter operatively connected to the battery pack;
a charger operatively connected to the battery pack; and
a DC-DC converter.
CLAUSE 7. The battery pack of clause 6, wherein the general BMS is configured to control a charging power level of the charger, based at least in part on the at least one voltage signal communicated to the general BMS from the cell monitoring IC of at least one of the battery modules.
CLAUSE 8. The battery pack of clause 6 or 7, wherein the general BMS is configured to supervise allowed operating zone operations of the plurality of battery cells of at least one battery module, based at least in part on the at least one voltage signal communicated to the general BMS from the cell monitoring IC of at least one of the battery modules.
CLAUSE 9. The battery pack of any one of clauses 6 to 8, wherein the general BMS is configured to perform at least one of:
detecting a DC-DC converter status of the DC-DC converter;
enabling the DC-DC converter; and
disabling the DC-DC converter.
CLAUSE 10. The battery pack of any one of clauses 1 to 9, wherein, for each battery module:
the battery cells of the plurality of battery cells are arranged in a plurality of cell subgroups connected in series; and
each cell subgroup of the plurality of cell subgroups includes a portion of the plurality of battery cells connected in parallel.
CLAUSE 11. The battery pack of clause 10, wherein, for each battery module:
the at least one sensor of the module BMS includes a plurality of voltage sensors; and
a given voltage sensor of the plurality of voltage sensors is operatively connected to a corresponding cell subgroup of the plurality of cell subgroups, the given voltage sensor measuring the voltage of the corresponding one of the plurality of cell subgroups.
CLAUSE 12. The battery pack of clause 10 or 11, wherein, for each battery module:
the module BMS further comprises a plurality of balancing resistances;
each balancing resistance of the plurality of balancing resistances is connected to a corresponding cell subgroup of the plurality of cell subgroups; and
each balancing resistance of the plurality of balancing resistances is configured to selectively at least partially discharge the corresponding one of the plurality of cell subgroups.
CLAUSE 13. The battery pack of any one of clauses 1 to 12, further comprising:
a plurality of communication wires communicatively connecting the module BMS of each battery module to the general BMS; and
a plurality of wiring brackets for securing the plurality of communication wires in place in the battery housing.
CLAUSE 14. The battery pack of clause 13, wherein:
for each battery module, the module BMS includes at least one module transformer physical layer (module TPL) connector;
the general BMS includes at least one general transformer physical layer (general TPL) connector; and
the plurality of communication wires is connected between the at least one general TPL connector and the at least one module TPL connector of the module BMS of each of the plurality of battery modules.
CLAUSE 15. The battery pack of any one of clauses 1 to 14, wherein:
the battery housing includes:
   a housing body,
   a first cover selectively connected to the housing body, a first chamber being defined between the housing body and the first cover, and
   a second cover selectively connected to the housing body on a side of the housing body opposite the first cover, a second chamber being defined between the housing body and the second cover;
   a first subgroup of the plurality of battery modules is disposed in the first chamber; and
   a second subgroup of the plurality of battery modules is disposed in the second chamber.
CLAUSE 16. The battery pack of any one of clauses 1 to 15, further comprising a DC-DC converter disposed in the battery housing.
CLAUSE 17. The battery pack of clause 16, wherein the general BMS is operatively connected to the DC-DC converter, the general BMS being powered by the DC-DC converter.
CLAUSE 18. The battery pack of clause 17, wherein:
the general BMS is further communicatively connected to the DC-DC converter; and
the general BMS is configured to manage operations of the DC-DC converter, the general BMS being configured for performing at least one of:
   detecting a fault condition of the DC-DC converter,
   enabling operations of the DC-DC converter, and
   disabling operations of the DC-DC converter.
CLAUSE 19. The battery pack of any one of clauses 1 to 18, wherein, for each battery module, the module board includes a printed circuit board (PCB), the integrated current collector being formed at least in part by the PCB.
CLAUSE 20. The battery pack of clause 19, wherein, for each battery module, each battery cell of the plurality of battery cells is connected to the integrated current collector via wire bonding.
CLAUSE 21. The battery pack of any one of clauses 1 to 20, further comprising: a plurality of bus bars electrically connecting in series the integrated current collectors of the plurality of battery modules.
CLAUSE 22. The battery pack of any one of clauses 1 to 21, wherein the general BMS further comprises at least one of:
at least one central processing unit (CPU); and
at least one read-only memory (ROM).
CLAUSE 23. The battery pack of any one of clauses 1 to 22, further comprising a battery disconnect unit (BDU) operatively connected to the general BMS, the general BMS being configured to manage operation of the BDU.
CLAUSE 24. The battery pack of clause 23, wherein:
the BDU comprises an insulation monitoring device (IMD) for monitoring electrical insulation resistance of a high voltage circuit, the high voltage circuit being formed at least in part by the battery pack;
the general BMS is communicatively connected to the IMD; and
the general BMS is configured to control battery pack operation based on signals received from the IMD.
CLAUSE 25. The battery pack of clause 23 or 24, wherein:
the general BMS is further communicatively connected to a high voltage interlock (HVIL) for monitoring high voltage connections of the electric vehicle;
the HVIL is at least partially connected to the BDU; and
the general BMS is configured to control battery pack operation based on information received from the HVIL.
CLAUSE 26. A method for managing a battery pack of an electric vehicle, the battery pack including a general battery management system (general BMS) operatively connected to a plurality of battery modules of the battery pack, each battery module including a module battery management system (module BMS), the method being executed by the general BMS, the method comprising:
receiving, from at least one sensor of the module BMS of a given battery module of the plurality of battery modules, at least one operational indicator of the given battery module; and
taking, based on the at least one operational indicator, at least one action relating to at least one battery pack component.
CLAUSE 27. The method of clause 26, wherein:
receiving the at least one operational indicator includes receiving voltage data relating to a plurality of battery cells;
the method further comprises determining an imbalance in voltage between at least two subgroups of the plurality of battery cells of the given battery module; and
taking the at least one action includes, causing at least one balancing resistance to discharge at least one subgroup of the plurality of battery cells.
CLAUSE 28. The method of clause 26, wherein receiving the at least one operational indicator includes receiving at least one voltage reading from at least one voltage sensor.
CLAUSE 29. The method of clause 28, further comprising determining that the at least one voltage reading represents a voltage of at least one cell of the battery module being outside of an allowed operating range.
CLAUSE 30. The method of clause 29, wherein the general BMS manages a component of the module BMS in response to determining that the component voltage is outside of the allowed operating range.
CLAUSE 31. The method of any one of clause 26 to 30, further comprising:
detecting a fault condition in a DC-DC converter of the battery pack, the DC-DC converter being communicatively connected to the general BMS; and
in response to detecting the fault condition, controlling at least one component of the DC-DC converter.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

1. A battery pack for an electric vehicle, the battery pack comprising:
a battery housing;
a general battery management system (general BMS) disposed in the battery housing; and
a plurality of battery modules disposed in the battery housing, each battery module of the plurality of battery modules comprising:
a plurality of battery cells; and
a module board comprising:
a module battery management system (module BMS) communicatively connected to the general BMS, the module BMS including at least one sensor for sensing at least one operating condition of the plurality of battery cells; and
an integrated current collector disposed within the battery module, the integrated current collector electrically coupling the plurality of battery cells together.

2. The battery pack of claim 1, wherein, for each battery module, the at least one sensor of the module BMS includes at least one voltage sensor.

3. The battery pack of claim 2, wherein, for each battery module:
the module BMS further comprises a cell monitoring integrated circuit (IC);
the cell monitoring IC is communicatively connected to the at least one voltage sensor;
the cell monitoring IC is further communicatively connected to the general BMS; and
the cell monitoring IC is configured for:
converting sensor information received from the at least one voltage sensor into at least one voltage signal, and
communicating the at least one voltage signal to the general BMS.

4. The battery pack of claim 2, wherein, for each battery module, the module BMS further comprises at least one temperature sensor.

5. The battery pack of claim 3, wherein the general BMS is configured to communicate with at least one powertrain component in response to a signal received by the general BMS from at least one module BMS of the plurality of the battery modules.

6. The battery pack of claim 5, wherein the at least one powertrain component includes at least one of:
an inverter operatively connected to the battery pack;
a charger operatively connected to the battery pack; and
a DC-DC converter.

7. The battery pack of claim 6, wherein the general BMS is configured to control a charging power level of the charger, based at least in part on the at least one voltage signal communicated to the general BMS from the cell monitoring IC of at least one of the battery modules.

8. The battery pack of claim 6, wherein the general BMS is configured to supervise allowed operating zone operations of the plurality of battery cells of at least one battery module, based at least in part on the at least one voltage signal communicated to the general BMS from the cell monitoring IC of at least one of the battery modules.

9. The battery pack of claim 6, wherein the general BMS is configured to perform at least one of:
detecting a DC-DC converter status of the DC-DC converter;
enabling the DC-DC converter; and
disabling the DC-DC converter.

10. The battery pack of claim 1, wherein, for each battery module:
the battery cells of the plurality of battery cells are arranged in a plurality of cell subgroups connected in series; and
each cell subgroup of the plurality of cell subgroups includes a portion of the plurality of battery cells connected in parallel.

11. The battery pack of claim 10, wherein, for each battery module:
the at least one sensor of the module BMS includes a plurality of voltage sensors; and
a given voltage sensor of the plurality of voltage sensors is operatively connected to a corresponding cell subgroup of the plurality of cell subgroups, the given voltage sensor measuring the voltage of the corresponding one of the plurality of cell subgroups.

12. The battery pack of claim 10, wherein, for each battery module:
the module BMS further comprises a plurality of balancing resistances;
each balancing resistance of the plurality of balancing resistances is connected to a corresponding cell subgroup of the plurality of cell subgroups; and
each balancing resistance of the plurality of balancing resistances is configured to selectively at least partially discharge the corresponding one of the plurality of cell subgroups.

13. (canceled)

14. The battery pack of claim 1, wherein:
for each battery module, the module BMS includes at least one module transformer physical layer (module TPL) connector;
the general BMS includes at least one general transformer physical layer (general TPL) connector; and
a plurality of communication wires is connected between the at least one general TPL connector and the at least one module TPL connector of the module BMS of each of the plurality of battery modules.

15. The battery pack of claim 1, wherein:
the battery housing includes:
a housing body,
a first cover selectively connected to the housing body, a first chamber being defined between the housing body and the first cover, and
a second cover selectively connected to the housing body on a side of the housing body opposite the first cover, a second chamber being defined between the housing body and the second cover;
a first subgroup of the plurality of battery modules is disposed in the first chamber; and
a second subgroup of the plurality of battery modules is disposed in the second chamber.

16. The battery pack of claim 1, further comprising a DC-DC converter disposed in the battery housing.

17. (canceled)

18. The battery pack of claim 16, wherein:
the general BMS is further communicatively connected to the DC-DC converter; and
the general BMS is configured to manage operations of the DC-DC converter, the general BMS being configured for performing at least one of:
detecting a fault condition of the DC-DC converter,
enabling operations of the DC-DC converter, and
disabling operations of the DC-DC converter.

19. The battery pack of claim 1, wherein, for each battery module, the module board includes a printed circuit board (PCB), the integrated current collector being formed at least in part by the PCB.

20.-22. (canceled)

23. The battery pack of claim 1, further comprising a battery disconnect unit (BDU) operatively connected to the general BMS, the general BMS being configured to manage operation of the BDU.

24. The battery pack of claim 23, wherein:
the BDU comprises an insulation monitoring device (IMD) for monitoring electrical insulation resistance of a high voltage circuit, the high voltage circuit being formed at least in part by the battery pack;
the general BMS is communicatively connected to the IMD; and
the general BMS is configured to control battery pack operation based on signals received from the IMD.

25. The battery pack of claim 23, wherein:
the general BMS is further communicatively connected to a high voltage interlock (HVIL) for monitoring high voltage connections of the electric vehicle;
the HVIL is at least partially connected to the BDU; and
the general BMS is configured to control battery pack operation based on information received from the HVIL.

26.-31. (canceled)
